(19) United States
(12) Patent Application Publication
(10) Pub. No.: US 2014/0094394 A1
(43) Pub. Date: Apr. 3, 2014

(54) High Density Weight Materials for Oil Field Servicing Operations

(71) Applicant: CHEVRON PHILLIPS CHEMICAL COMPANY LP, The Woodlands, TX (US)

(72) Inventors: Marshall D. BISHOP, Bartlesville, OK (US); John E. ANDERSON, Bartlesville, OK (US)

(73) Assignee: Chevron Phillips Chemical Company LP, The Woodlands, TX (US)

(21) Appl. No.: 13/633,631

(22) Filed: Oct. 2, 2012

(51) Int. Cl. C09K 8/60; C09K 8/05

(52) U.S. Cl. 507/143; 507/270; 507/269; 507/140; 106/640; 106/638

(57) ABSTRACT

A wellbore treatment fluid comprising one or more high-density weighting materials selected from the group consisting of tungsten-containing materials, bismuth-containing materials, and tin-containing materials.

### TECHNICAL FIELD

This disclosure relates to servicing an oil field. More specifically, this disclosure relates to servicing fluids and methods of making and using same.

### BACKGROUND

Subterranean deposits of natural resources such as gas, water, and crude oil are commonly recovered by drilling wells to tap subterranean formations or zones containing such deposits. Various fluids are employed in drilling a well and preparing the well and an adjacent subterranean formation for the recovery of material therefrom. For example, a drilling fluid or “mud” is usually circulated through a wellbore as it is being drilled to cool the bit, keep deposits confined to their respective formations during the drilling process, counterbalance formation pressure, and transport drill cuttings to the surface.

Well production operations designed to recover natural resources employ a number of servicing fluids with very specific properties for each individual application. An ongoing need exists for materials useful for adjusting the properties of the servicing fluids to meet some user and/or process need.

### SUMMARY

Disclosed herein is a wellbore treatment fluid comprising one or more high-density weighting materials selected from the group consisting of tungsten-containing materials, bismuth-containing materials, and tin-containing materials.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and the advantages thereof, reference is now made to the following brief description, taken in connection with the accompanying drawings and detailed description:

FIGS. 1, 2 and 3 are plots of slurry viscosity as a function of time for the samples from Example 4.

### DETAILED DESCRIPTION

Disclosed herein are wellbore servicing fluids comprising a high density weighting material (HDWM). As used herein a “wellbore treatment fluid” (WTF) refers to a fluid designed and prepared to resolve a specific wellbore or reservoir condition. Wellbore treatment fluids are used in a variety of wellbore operations that include for example the isolation or control of reservoir gas or water, preparation of a wellbore or a subterranean formation penetrated by the wellbore for the recovery of material from the formation, for the deposit of material into the formation, or combinations thereof. It is to be understood that “subterranean formation” encompasses both areas below exposed earth or areas below earth covered by water such as sea or ocean water.

The WTF may comprise a cement slurry, a drilling fluid, a completion fluid, a work-over fluid, a fracturing fluid, a sweeping fluid, or any other suitable wellbore treatment fluid. In an embodiment, WTFs containing a HDWM of the type disclosed herein may have some user and/or process desired density while containing a reduced amount of weighting material when compared to an otherwise similar WTF lacking a HDWM of the type disclosed herein. HDWMs, their use in WTFs and advantages thereof are described in more detail herein.

In an embodiment, the HDWM comprises any material that has a specific gravity (SG) value greater than about 5.0, alternatively greater than about 5.2, or alternatively greater than about 5.5. SG is a dimensionless quantity, and is defined as the ratio between the density of the material and the density of water, where both densities have been measured under the same conditions of pressure and temperature. Unless otherwise specified, SG values are given for measurements taken at atmospheric pressure (1.013×10⁵ Pa) and a temperature of 20° C. and can be determined in accordance with the Le Chatelier flask method as shown in API 13A 7.3.

In an embodiment, the HDWM comprises a naturally-occurring material. Alternatively, the HDWM comprises a synthetic material. Alternatively, the HDWM comprises a mixture of a naturally-occurring and a synthetic material.

In an embodiment, the HDWM comprises a tungsten-containing material. Non-limiting examples of tungsten-containing materials suitable for use in the present disclosure include scheelite, wolframite, tungsten metal powder, and other tungsten metal oxides (e.g., cuproscheelite Cu₂(WO₄)(OH)₂), or combinations thereof. In an embodiment, the HDWM comprises bismuth-containing materials. Non-limiting examples of bismuth-containing materials suitable for use in this disclosure include bismuthinite, bismite, bismuth metal powder, and other bismuth metal oxides or sulfides, or combinations thereof. In an embodiment, the HDWM comprises tin-containing materials. Non-limiting examples of tin-containing materials suitable for use in this disclosure include cassiterite, romarchite, tin metal, tin metal oxides or sulfides, or combinations thereof.

In an embodiment, the HDWM excludes or is substantially free of galena-containing and/or lead-containing minerals. Alternatively galena and/or lead may be present in the HDWM in an amount of less than about 1% by weight of the HDWM.

In an embodiment, the HDWM comprises scheelite also known as scheelerz. Scheelite suitable for use as a HDWM in this disclosure can be a naturally-occurring tungstate mineral, synthetic scheelite, or a combination thereof. Pure scheelite has the chemical formula CaWO₄ and is known as calcium tungstate. Scheelite has a SG ranging from about 5.9 to about 6.1 and a hardness ranging from about 4.5 to about 5 on the Mohs scale. Hardness herein refers to scratch hardness which is defined as the ability of a material to withstand permanent plastic deformation when in contact with a sharp object. The Mohs scale is a relative scratch hardness scale with values ranging from 1 to 10, where talc is defined as the least hard material (i.e., softest) with a value of 1, and diamond is defined as the hardest material with a value of 10.

In an embodiment, the HDWM comprises cuproscheelite which is a naturally-occurring tungstate mineral, and can be found either alone or in combination with scheelite. Cuproscheelite has the chemical formula Cu₂(WO₄)(OH)₂ and is also known as cuprotungstite. Cuproscheelite has a SG ranging from about 5.4 to about 7 and a hardness ranging from about 4 to about 5 on the Mohs scale.

In an embodiment, the HDWM comprises wolframite which is a naturally-occurring tungstate mineral. Wolframite has the chemical formula (Fe,Mn)WO₄, and is an iron manganese tungstate that is a combination of ferberite (Fe²⁺)WO₄, and hubnerite (Mn²)WO₄. Wolframite has a SG ranging from about 7.0 to about 7.5 and a hardness ranging from about 4 to about 4.5 on the Mohs scale.

In an embodiment, the HDWM comprises tungsten metal in powder form which is described with the chemical symbol W, and the atomic number 74, and is naturally found in combination with other elements. For example, tungsten metal can be found in minerals such as scheelite and wolframite, from which it can be isolated and purified using suitable methodologies. Tungsten metal powder has a SG of about 19.25 and a hardness of about 7.5 on the Mohs scale.

Typical impurities for tungsten-containing materials include cassiterite, topaz, fluorite, apatite, tourmaline, quartz, andradite, diopside, vesuvianite, tremolite, bismuth, pyrite, galena, sphalerite, arsenopyrite, molybdenum and rare earth elements comprising praseodymium, neodymium, and the like. As can be understood by one skilled in the art the overall SG of the HDWM is not dictated by the impurities present in a HDWM comprising tungsten-containing materials. Alternatively, the impurities are not present in a sufficient amount to be responsible for the overall SG of the HDWM. In an embodiment, the tungsten-containing materials are treated to reduce and/or eliminate one or more of these impurities.

In an embodiment, the HDWM comprises bismuthinite, which is a naturally-occurring bismuth mineral. Pure bismuthinite has the chemical formula Bi₂S₃ and is also known as bismuth sulfide. Bismuthinite has a SG ranging from about 6.8 to about 7.25 and a hardness ranging from about 2 to about 2.5 on the Mohs scale.

In an embodiment, the HDWM comprises bismite, which is a naturally-occurring bismuth mineral. Pure bismite has the chemical formula Bi₂O₃ and is also known as bismuth trioxide. Bismite has a SG ranging from about 8.5 to about 9.5 and a hardness ranging from about 4 to about 5 on the Mohs scale.

In an embodiment, the HDWM comprises bismuth metal in powder form which is described with the chemical symbol Bi, and the atomic number 73, and is a naturally-occurring mineral. Bismuth metal powder has a SG of about 9.78 and a hardness ranging from about 2 to about 2.5 on the Mohs scale. Commercially available bismuth metal powder is not usually extracted from native bismuth, but is rather a byproduct of mining and refining other metals, such as lead, copper, tin, silver and gold.

Typical impurities for bismuth-containing materials include aikinite, arsenopyrite, stannite, galena, pyrite, chalcopyrite, tourmaline, wolframite, cassiterite, quartz, and antimony. As can be understood by one skilled in the art the overall SG of the HDWM is not dictated by the impurities present in a HDWM comprising bismuth-containing materials. Alternatively, the impurities are not present in a sufficient amount to be responsible for the overall SG of the HDWM. In an embodiment, the bismuth-containing materials are treated to reduce and/or eliminate one or more of these impurities.

In an embodiment, the HDWM comprises cassiterite, which is a naturally-occurring tin mineral. Pure cassiterite has the chemical formula SnO₂ and is also known as tin (IV) oxide. Casiterite has a SG ranging from about 6.8 to about 7.1 and a hardness ranging from about 6 to about 7 on the Mohs scale.

In an embodiment, the HDWM comprises romarchite, which is a naturally-occurring tin mineral. Pure romarchite has the chemical formula SnO and is also known as tin (II) oxide. Romarchite has a SG of about 6.4 and a hardness ranging from about 2 to about 2.5 on the Mohs scale.

In an embodiment, the HDWM comprises tin metal which is described with the chemical symbol Sn, and the atomic number 50, and is a naturally-occurring mineral. Tin is commonly found in two allotropic forms, α-tin and β-tin. As used herein the term “tin” refers to the 13-tin metallic allotrope. Tin metal has a SG of about 7.3 and a hardness of about 2 on the Mohs scale. Commercially available tin metal is not usually extracted from native tin, but is rather a product of refining other minerals, such as cassiterite.

Typical impurities for tin-containing materials include quartz, pegmatites, granite, tourmaline, topaz, fluorite, calcite, apatite, wolframite, molybdenite, herzenbergite, arsenopyrite, bismuth, antimony, and silver. As can be understood by one skilled in the art the overall SG of the HDWM is not dictated by the impurities present in a HDWM comprising tin-containing materials. Alternatively, the impurities are not present in a sufficient amount to be responsible for the overall SG of the HDWM. In an embodiment, the tin-containing materials are treated to reduce and/or eliminate one or more of these impurities.

In an embodiment, the HWDMs of the type described previously herein are commercially available in solid and/or powder form and may be characterized by a particle size distribution passing through a 200 mesh (75 microns) sieve. The mesh size refers to the number of openings per linear inch (e.g., 200 mesh) through which the particles pass. Thus particles characterized by a 200 mesh particle size are able to pass through a sieve having an aperture of approximately 75 microns, i.e., all particles that have as the largest dimension 75 microns or less pass through the sieve openings. Alternatively, in an embodiment, the HDWM may be characterized by a particle size distribution ranging from about 300 microns (i.e., 50 mesh) to about less than about 3 microns, alternatively from about 75 microns (i.e., 200 mesh) to about 20 microns (i.e., 635 mesh). Alternatively, in another embodiment, the HDM may be characterized by a particle size ranging from about 20 microns to about 0.001 microns, alternatively from about 5 microns to about 0.01 microns, or alternatively from about 3 microns to about 0.1 microns, and such sub-20 micron particles may be beneficial in certain instances, for example having less tendency to settle in the drilling fluid. In an embodiment, the HWDMs are sized such that the HWDM particles would pass through the solids control equipment on a drilling rig (e.g., 200 mesh screens) that are typically used to remove large solids such as drill cutting while allowing smaller particles to remain suspended in the drilling fluid, which may be beneficial to impart certain desired properties to the fluid.

A weighting agent comprising a HDWM of the type disclosed herein can be included in any WTF that conventionally employs weighting materials such as cement slurries, wellbore drilling fluids, completion fluids, and the like.

In an embodiment, the WTF comprises a cement slurry. Cement slurries suitable for use in wellbore servicing operations typically comprise cementitious material, aqueous fluid, a weighting material, and any additives that may be needed to modulate the properties of the cement slurry.

In an embodiment, the cementitious material comprises a hydraulic cement binder. The term “hydraulic cement binder” as used herein refers to a substance that sets and hardens independently and can bind other materials together. Examples of such hydraulic cement binders include Portland cement blends, Pozzolan-lime cements, slag cements, calcium aluminate cements, natural cements, geopolymer cements, microfine cements and fine grind lightweight type cements. Hereinafter, the disclosure will refer to cement slurries or cement compositions comprising a hydraulic cement binder although it is to be understood the cement compositions comprising other types of cementitious materials are also contemplated. The cementitious material may be present in the cement slurry in an amount ranging from about 10 wt. % to about 90 wt. %, alternatively from about 15 wt. % to about 80 wt. %, or alternatively from about 20 wt. % to about 75 wt. % based on the mass of hydraulic cement binder in the total slurry.

Any suitable aqueous fluid may be used in preparation of the cement slurry. As used herein, the phrase “aqueous fluid” is understood to include fresh water, salt water, seawater, or brine. The aqueous fluid is present in the cement slurry in an amount sufficient to form a slurry that can be pumped downhole. Typical concentrations of aqueous fluid present in the cement slurry may range from about 10 wt. % to about 300 wt. % by weight of cement, alternatively from about 20 wt. % to about 150 wt. %, or alternatively from about 30 wt. % to about 100 wt. %. In an embodiment, the amount of water and the amount of cementitious material can be selected to provide end-user desired characteristics, such as cement hardness, setting time, pumping viscosity, pumping time, and the like.

The amount of HDWM used in a cement slurry is any amount effective to produce the desired user and/or process characteristics for the cement slurry, such as density. In an embodiment, the HDWM may be present in the cement slurry in amounts ranging from about 5 wt. % to about 150 wt. % by weight of cement, alternatively from about 10 wt. % to about 125 wt. %, or alternatively from about 10 wt. % to about 100 wt. %. In an embodiment, the density of a cement slurry may be greater than about 16 pounds per gallon (ppg) (1.92 kg/L), alternatively greater than about 18 ppg (2.16 kg/L), or alternatively greater than about 20 ppg (2.40 kg/L). The density of a material which may comprise a WTF is defined as the ratio between its mass and unit volume. Density can be practically determined by measuring the mass of a predetermined volume of material and dividing the mass by the volume, where both the mass and the volume have been measured under the same conditions of pressure and temperature. Unless otherwise specified, density values are given for measurements taken at atmospheric pressure (1.013×10⁵ Pa) and a temperature of 20° C., and are expressed in ppg. Mass and volume can be measured by one of ordinary skill in the art by using a mud balance or an automated in line densitometer.

The amount of HDWM present in the cement slurry or any WTF is based on use of the commercially available HDWMs of the type disclosed herein which typically contain some amount of impurities.

In an embodiment, the WTF comprises a drilling fluid also known as a drilling mud. In an embodiment, the drilling fluid comprises a water-based mud, an oil-based mud, an emulsion, or an invert emulsion.

In an embodiment, the WTF is a water-based mud (WBM). As used herein, a WBM includes fluids that are comprised substantially of aqueous fluids, and/or emulsions wherein the continuous phase is an aqueous fluid. WBMs may also comprise a weight agent, and typically additionally contain clays or organic polymers and other additives as needed to modify the properties of the fluid to meet some user and/or process need. In some embodiments, the amount of aqueous fluid present in the WTF (e.g., drilling fluid) is maximized in relation to the remaining components of the WTF, with the minimal amount of remaining components selected and incorporated such that the WTF has the requisite properties needed for a given wellbore treatment.

The aqueous fluid used for preparing the WBM may be fresh water, sea water, or brine. In an embodiment, brine includes any aqueous salt solutions suitable for use in oil field operations. In an embodiment, the aqueous fluid is present in the WBM in amounts ranging from about 60% to about 99%, alternatively from about 70% to about 98%, or alternatively from about 75% to about 95% based on the volume of the WBM.

In an embodiment, the WBM is an emulsion drilling fluid comprising a non-aqueous fluid (discontinuous phase) dispersed in an aqueous phase (continuous phase). The non-aqueous fluid may comprise oleaginous fluids of the type described herein. The aqueous phase may comprise any of the aqueous fluids described previously herein such as fresh water or salt water. Such aqueous fluids may be present in an emulsion drilling fluid in an amount ranging from about 50% to about 99%, alternatively from about 70% to about 95%, or alternatively from about 75% to about 95%, while the non-aqueous fluids may be present in an amount ranging from about 1% to about 50%, alternatively from about 5% to about 30%, or alternatively from about 5% to about 25%, based on the volume of the liquid phase.

The amount of HDWM used in the WBM (e.g., aqueous, emulsion) is any amount effective to produce the desired user and/or process characteristics for the drilling mud, such as density. In an embodiment, the HDWM may be present in the WBM in an amount of from about 1 wt. % to about 80 wt. %, alternatively from about 5 wt. % to about 75 wt. %, or alternatively from about 10 wt. % to about 70 wt. %, based on the total mass of the WBM. The resulting WBM may have a density greater than about 8.3 ppg (1 kg/L), alternatively greater than about 9 ppg (1.08 kg/L), or alternatively greater than about 10 ppg (1.20 kg/L).

In an embodiment, the WTF comprises an oil-based mud (OBM). The OBM may include fluids that are comprised entirely or substantially of non-aqueous fluids and/or invert emulsions wherein the continuous phase is a non-aqueous fluid. OBMs may also comprise a weight agent, and typically additionally contain clays or organic polymers and other additives as needed to modify the properties of the fluid to meet some user and/or process need.

In various embodiments, the non-aqueous fluids contained within the OBM comprise one or more liquid hydrocarbons, one or more water insoluble organic chemicals, or combinations thereof. The non-aqueous fluid may, for example, comprise diesel oil, mineral oil, an olefin, an organic ester, a synthetic fluid, olefins, kerosene, fuel oil, linear or branched paraffins, acetals, mixtures of crude oil or combinations thereof. In an embodiment, the non-aqueous fluid is a synthetic hydrocarbon. Examples of synthetic hydrocarbons suitable for use in this disclosure include without limitation linear-α-olefins, polyalphaolefins (unhydrogenated or hydrogenated), internal olefins, esters, or combinations thereof. The non-aqueous fluids may be present in an amount of from about 50% to about 99%, alternatively from about 70% to about 95%, or alternatively from about 75% to about 95%, based on the OBM volume.

In an embodiment, the OBM comprises less than about 10% aqueous fluids (e.g., water) by total weight of the OBM, alternatively less than about 5% aqueous fluids, alternatively less than about 1% aqueous fluids, alternatively less than about 0.1% aqueous fluids, alternatively the OBM is substantially free of aqueous fluids.

In an embodiment, the OBM is an invert emulsion drilling fluid comprising aqueous fluid (discontinuous phase) dispersed in a non-aqueous phase (continuous phase). The aqueous fluid may comprise any of the aqueous fluids described previously herein such as fresh water or salt water. The non-aqueous phase may comprise oleaginous fluids of the type previously described herein. Such non-aqueous fluids may be present in an invert emulsion drilling fluid in an amount ranging from about 50% to about 99%, alternatively from about 70% to about 95%, or alternatively from about 75% to about 95%, while the aqueous fluids may be present in an amount ranging from about 1% to about 50%, alternatively from about 5% to about 40%, or alternatively from about 10% to about 30% based on the volume of the liquid phase.

The amount of HDWM used in an OBM (e.g., non-aqueous, invert emulsion) is any amount effective to produce the desired user and/or process characteristics for the drilling mud, such as density. In an embodiment, the HDWM may be present in the OBM in an amount of from about 1 wt. % to about 80 wt. %, alternatively from about 5 wt. % to about 75 wt. %, or alternatively from about 75 wt. % to about 95 wt. % based on the total weight of the OBM. The resulting OBM comprising a HDWM of the type disclosed herein may have a density of greater than about 8 ppg (0.96 kg/L), alternatively greater than about 9 ppg (1.08 kg/L), or alternatively greater than about 10 ppg (1.20 kg/L).

In some embodiments, the WTF may comprise additional additives as deemed appropriate by one skilled in the art for improving the properties of the fluid. Such additives may vary depending on the intended use of the fluid in the wellbore. In an embodiment, the WTF is a cement slurry of the type disclosed herein and may include additives such as weighting agents, fluid loss agents, glass fibers, carbon fibers, hollow glass beads, ceramic beads, suspending agents, conditioning agents, retarders, dispersants, water softeners, oxidation and corrosion inhibitors, bactericides, thinners, and the like. In an embodiment, the WTF is a drilling fluid of the type disclosed herein and may include clays, organic polymers, viscosifiers, scale inhibitors, fluid loss additives, friction reducers, thinners, dispersants, temperature stability agents, pH-control additives, calcium reducers, shale control materials, emulsifiers, surfactants, bactericides, defoamers, and the liked. These additives may be included singularly or in combination. Methods for introducing these additives and their effective amounts are known to one of ordinary skill in the art.

In an embodiment, the use of a HDWM of the type disclosed may allow for the cement slurry density to reach values of greater than about 16.5 ppg (1.98 kg/L), alternatively greater than about 20 ppg (2.40 kg/L), or alternatively greater than about 22 ppg (2.64 kg/L). Such slurries may be further characterized as containing a greater amount of hydraulic cement binder when compared to a cement slurry of similar density lacking a HDWM of the type disclosed herein. As will be understood by one of ordinary skill in the art with the aid of this disclosure, in order to increase the density of the cement slurry, one adds weighting agents to the composition. Conventionally, the addition of the weighting agents is offset by the removal of some amount of the hydraulic cement binder and/or water. Thus, as the density desired for some user and/or process goal increases, cement slurries comprising conventional weighting agents will have a concomitant reduction in the amount of hydraulic cement binder and/or water present. The reduction in the amount of hydraulic cement binder present in the cement slurry may negatively impact the wellbore servicing operations in a variety of ways such as making it challenging to control the thickening time (setting time) of the cement slurry, negatively impacting the rheological properties of the cement slurry, and/or lowering the compressive strength of the cement. As the concentration of the solids increases, controlling the properties of the fluid, (i.e., cement slurry) also becomes challenging. Cement slurries comprising a HDWM of the type disclosed herein may require lesser amounts of weighting agents and consequently may have an increased hydraulic cement binder and/or water content when compared to cement slurries of similar densities prepared in the absence of an HDWM of the type disclosed herein, such as for example a cement having the same density and all other components identical with the exception that the weighting material comprises hematite or barite.

In an embodiment, a cement slurry comprising a HWDM of the type disclosed herein may have a hydraulic cement binder content that is greater than about 1%, alternatively greater than about 5%, or alternatively greater than about 10%, when compared to a cement slurry composition of similar density lacking a HDWM of the type disclosed herein or comprising a conventional weighting agent. In some embodiments, the amount of hydraulic cement binder present in the cement composition comprising a HDWM of the type disclosed herein is greater than that in an otherwise similar cement composition having an identical density.

In a drilling mud that uses conventional weighting agents, such as barite or ilmenite, while there may be achievable densities for the drilling muds of about 22 ppg (2.64 kg/L), as a practical matter densities of equal to or greater than about 19 ppg (2.28 kg/L) are difficult to achieve and maintain. As the concentration of the solids increases, it becomes more and more difficult to control the properties of the fluid, (i.e., drilling fluid). In an embodiment, the use of a HDWM may allow for the drilling mud density to reach values equal to or greater than about 19, 20, 21, 22, 23, or 24 ppg (2.28, 2.40, 2.52, 2.76 or 2.88 kg/L).

One problem associated with the use in drilling muds of conventional weighting agents such as hematite and ilmenite is their abrasivity. For the purposes of this disclosure, abrasivity is directly proportional to the hardness of the material on the Mohs scale, i.e., the softer the material, the less abrasive it is. In an embodiment, the HDWMs disclosed herein have a Mohs hardness less than that of a conventional weighting agent such as hematite and/or ilmenite, and as a result the drilling mud may display a reduced abrasivity. The reduction in abrasivity of the drilling fluid may reduce the amount of wear exerted on the oilfield servicing equipment by the drilling fluid e.g., may reduce the wear on the drill bit.

In an embodiment, HDWMs with particle sizes of smaller than about 20 microns may be advantageously used in some drilling fluid applications. Without wishing to be limited by theory, extremely small particles (i.e., in the tens of microns and nanometer range) have a lower tendency to settle in a fluid when compared to larger size particles (e.g., larger than about 20 microns). In an embodiment, HDWMs suitable for such applications comprise particle sizes ranging from about 1 nm to about 20 microns, alternatively from about 10 nm to about 10 microns, or alternatively from about 100 nm to about 1 micron.

As discussed previously herein use of HDWMs of the type disclosed herein results in less weighting agent being used to achieve some user and/or process desired density. In some embodiments, the use of lesser amounts of a weighting agent affords the operator the ability to supplement the WTF (e.g., OBM, cement slurry, WBM) with increased amounts of the component materials or with the inclusion of differing components as needed to meet some user and/or process goal. For example, a WBM comprising a HWDM of the type disclosed herein may be formulated to have an aqueous fluid (e.g., water) content that is increased by greater than about 2.5 wt. % when compared to a WBM of similar density lacking a HDWM of the type disclosed herein, alternatively greater than about 5 wt. %, alternatively greater than about 10 wt. %, alternatively greater than about 15 wt. %, or alternatively greater than about 20 wt. %. Alternatively, the disclosed increase in aqueous fluid content may be observed for a WBM of the type disclosed when compared to a WBM having an identical composition and density with the exception that the weighting material is not a HDWM of the type disclosed herein.

In another embodiment, an OBM comprising a HWDM of the type disclosed herein may be formulated to have a non-aqueous fluid content that is increased by greater than about 1 wt. %, alternatively greater than about 5 wt. %, alternatively greater than about 50 wt. %, or alternatively greater than from about 100 wt. %, when compared to an OBM of similar density lacking a HDWM of the type disclosed herein. Alternatively, the disclosed increase in non-aqueous fluid content may be observed for an OBM of the type disclosed when compared to an OBM having an identical composition and density with the exception that the weighting material is not a HDWM of the type disclosed herein.

In some embodiments, similar increases in the amount of aqueous fluid for a WBM or non-aqueous fluid for an OBM are observed in WTFs comprising a HDWM of the type disclosed herein when compared to an otherwise similar composition of identical density comprising a conventional weighting agent. Herein conventional weighting agents refer to weighting agents routinely employed in WTFs and include barite, hematite, ilmenite, carbonates such as calcium carbonates and dolomite, and the like.

HDWMs of the type disclosed herein advantageously employ a lesser amount of weighting agent in order to achieve a similar density when compared to a conventional weighting agent. As will be understood by the ordinarily skilled artisan with the aid of this disclosure, the extent of the reduction observed in the amount of weighting agent used when employing a HDWM of the type disclosed herein will depend on the nature of the weighting agent that was previously used. In an embodiment, an HDWM of the type disclosed herein may provide a reduction in the amount of weighting material used to achieve the same density of WTF ranging from about 1% to about 75%, alternatively from about 3% to about 50%, or alternatively from about 5% to about 25% when compared to use of a conventional weighting agent.

Without wishing to be limited by theory, reductions in the amount of weighting material required to achieve some user and/or process desired density may allow for the inclusion of an increased amount of other materials in the WTF that improve the mechanical and/or physical properties of the WTF. In an embodiment, the WTF comprising a HDWM of the type disclosed herein displays improved rheological characteristics when compared to an otherwise similar WTF of similar or identical density lacking an HDWM of the type disclosed herein.

In an embodiment, the WTF is a drilling fluid (e.g., OBM) comprising a HDWM of the type disclosed herein. In such embodiments, the WTF may be characterized by a reduced plastic viscosity; a reduced yield point; and a reduced gel strength at 10 seconds: gel strength at 10 minutes, when compared to the values obtained with an otherwise similar WTF comprising a conventional weighting material. The plastic viscosity (PV) is an absolute flow property indicating the flow resistance of certain types of fluids and is a measure of shearing stress while the yield point (YP) refers to the resistance of the drilling fluid to initial flow, or represents the stress required to start fluid movement. Practically, the YP is related to the attractive force among colloidal particles in drilling mud. Gel Strength is a static measurement in that the measurement is determined after the fluids have been static for a defined time frame. During this time, a dynamic equilibrium based on diffusional interfacial interactions is reached which also determines the stability of the fluid or the ability to suspend cuttings. The plastic viscosity, yield point and gel strength may be determined by Fann 35 Rheometric analysis.

In an embodiment, the WTF comprises a HDWM of the type disclosed herein which could be used in any suitable oil field operation. In particular, the WTF comprising the HDWM of the type disclosed herein can be introduced into a wellbore and used to service the wellbore in accordance with suitable procedures.

For example, when the intended use of the WTF is as a cement slurry, the cement slurry may be added to the wellbore to secure the casing around the annulus or to secure a casing inside a larger casing. Alternatively, cement slurries may be used for plugging certain features in the downhole formation, such as sealing off the formation to prevent drilling fluid loss. Alternatively, the cement slurry may be used in squeeze cementing for consolidating already existing cement structures in the wellbore. The cement slurry may exhibit particular properties, such as high pumpability that would allow it to travel over long distances through the annulus. Once the cement slurry is introduced into the wellbore at the desired depth/distance, the cement may set and harden such that it can withstand the downhole pressure conditions for the subsequent oil field servicing operations.

In an embodiment, the cement slurry comprising the HDWM is prepared at the wellsite. For example, the HDWM may be mixed with the other cement slurry components and then pumped downhole.

In an embodiment, the intended use of the WTF is as a drilling fluid (e.g., OBM) which could be used in any suitable oil field operation. In particular, the drilling fluid comprising a HDWM of the type disclosed herein can be displaced into a wellbore and used to service the wellbore in accordance with suitable procedures. For example, the drilling fluid can be circulated down through a hollow drill stem or a drill string and out through a drill bit attached thereto while rotating the drill stem to thereby drill the wellbore. The drilling fluid will flow back to the surface to carry drill cuttings to the surface, and deposit a filtercake on the walls of the wellbore. The thickness of the filtercake will be dependent on the nature of the formation and components of the drilling fluid. The HDWM may be included in the drilling fluid prior to the fluid being placed downhole in a single stream embodiment. Alternatively, the HDWM may be mixed with the other components of the drilling fluid during placement into the wellbore for example in a two-stream process wherein one stream comprises the HDWM and a second stream comprises the other components of the drilling fluid. In an embodiment, the drilling fluid comprising the HDWM is prepared at the wellsite. For example the HDWM may be mixed with the other drilling fluid components and then placed downhole. Alternatively, the drilling fluid comprising the HDWM is prepared offsite and transported to the use site before being placed downhole.

The following are additional enumerated embodiments of the concepts disclosed herein.

A first embodiment which is a wellbore treatment fluid comprising one or more high-density weighting materials selected from the group consisting of tungsten-containing materials, bismuth-containing materials, and tin-containing materials.

A second embodiment which is the wellbore treatment fluid of the first embodiment comprising one or more tungsten-containing materials selected from the group consisting of tungsten metal, scheelite, wolframite, and cuproscheelite.

A third embodiment which is the wellbore treatment fluid of the first or second embodiment comprising one or more bismuth-containing materials selected from the group consisting of bismuth metal, bismuthinite, and bismite.

A fourth embodiment which is the wellbore treatment fluid of one of the first through third embodiments comprising one or more tin-containing materials selected from the group consisting of tin metal, cassiterite, and romarchite.

A fifth embodiment which is the wellbore treatment fluid of one of the first through fourth embodiments wherein the treatment fluid is formulated as a drilling fluid or a settable sealant composition.

A sixth embodiment which is the wellbore treatment fluid of the fifth embodiment wherein the wellbore treatment fluid is formulated as a drilling fluid comprising (i) one or more liquids selected from the group consisting of an aqueous liquid and an oleaginous liquid having and (ii) an effective amount of the high-density weighting material such that the wellbore treatment fluid has a density greater than about 9 ppg (1.08 kg/L).

A seventh embodiment which is the wellbore treatment fluid of the sixth embodiment wherein the treatment fluid is a water-based drilling mud or an oil-based drilling mud.

An eighth embodiment which is the wellbore treatment fluid of any one of the first through seventh embodiments wherein the high-density weighting material is present in amount of from about 1 wt. % to about 80 wt. % based on the total weight of the treatment fluid.

A ninth embodiment which is a wellbore treatment fluid formulated as a settable sealant composition comprising (i) an effective amount of a hydraulic cement binder to form a settable composition, (ii) an effective amount of an aqueous fluid to form a pumpable slurry, and (iii) an effective amount of one or more high-density weighting materials such that the slurry has a density greater than about 16.5 ppg (1.98 kg/L), wherein the one or more high-density weighting materials is selected from the group consisting of tungsten-containing materials, bismuth-containing materials, and tin-containing materials.

A tenth embodiment which is the wellbore treatment fluid of ninth embodiment comprising one or more hydraulic cement binders selected from the group consisting of Portland cement blends, Pozzolan-lime cements, slag cements, calcium aluminate cements, natural cements, geopolymer cements, microfine cements, and fine grind lightweight type cements.

An eleventh embodiment which is the wellbore treatment fluid of the ninth or tenth embodiment wherein the high-density weighting material comprises a material with a specific gravity greater than about 5.5.

A twelfth embodiment which is the wellbore treatment fluid of tenth embodiment comprising one or more tungsten-containing materials selected from the group consisting of tungsten metal in powder form and a tungsten metal oxide.

A thirteenth embodiment which is the wellbore treatment fluid of twelfth embodiment comprising one or more tungsten metal oxides selected from the group consisting of scheelite, wolframite, and cuproscheelite.

A fourteenth embodiment which is the wellbore treatment fluid of tenth embodiment comprising one or more bismuth-containing materials selected from the group consisting of bismuth metal in powder form, a bismuth metal oxide, and a bismuth metal sulfide.

A fifteenth embodiment which is the wellbore treatment fluid of tenth embodiment comprising one or more bismuth-containing materials selected from the group consisting of bismuthinite and bismite.

A sixteenth embodiment which is the wellbore treatment fluid of the tenth embodiment comprising one or more tin-containing materials selected from the group consisting of tin metal, a tin metal oxide, and a tin metal sulfide.

A seventeenth embodiment which is the wellbore treatment fluid of tenth embodiment comprising one or more tin-containing materials selected from the group consisting of cassiterite and romarchite.

An eighteenth embodiment which is the wellbore treatment fluid of one of the first through seventeenth embodiments wherein the high-density weighting material is characterized by a particle size distribution of equal to or less than about 200 mesh (75 μm).

A nineteenth embodiment which is the wellbore treatment fluid of one of the first through eighteenth embodiments wherein the high-density weighting material is present in amount of from about 5 wt. % wt. % to about 150 wt. % based on the total weight of the wellbore treatment fluid.

A twentieth embodiment which is a method comprising placing the wellbore treatment fluid of any preceding claim into a wellbore.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

The amount and volume of weighting agent necessary to achieve a WBM density of 18 ppg (2.16 kg/L) was investigated. Each sample contained water, 10 pounds per barrel (lbs/bbl) (28.5 kg/m³) bentonite, 1.5 lbs/bbl (4.3 kg/m³) DRISPAC polymer, and 1 lbs/bbl (2.85 kg/m³) CF DESCO deflocculant. DRISPAC polymer is a viscosity modifier based on a polyanionic cellulose polymer and CF DESCO deflocculant is a chrome free tannin-based deflocculant, both of which are commercially available from Chevron Philips Chemical Company LP. For each table, the components of each WBM are presented along with the density and the specific gravity of each component. The amount of material necessary (weight in pounds) per barrel (bbl) of final total target volume is given in each table. The amount of material (weight in pounds) necessary to prepare 1000 barrels (bbls) (159 m³) of a 18 ppg (2.16 kg/L) WBM was calculated and the amount of material (volume in barrels) to achieve the target volume and density is also presented. Table 1 provides the values for a WBM using barite as a weighting material while for Tables 2, 3, and 4 the barite is replaced with scheelite, wolframite and tungsten metal powder respectively. Scheelite, wolframite and tungsten metal powder are obtained from commercial sources processing the ore by either a gravity process or froth flotation. Briefly, during froth flotation, a mineral ore is thoroughly mixed/agitated by air purging in an aqueous slurry containing a surfactant, and the top part of the slurry is decanted and collected as froth flotation concentrate.

TABLE 1

| | |
|---|---|
| Target Volume | 1000 bbls (159 m³) |
| Target Density | 18 lb/gallon (2.16 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of | | | Density | Required for | | Required for | |
| ADDITIVES | Target Volume | | SG | [lbs/bbl] | Target Volume | | Target Volume | |
| Water | 221.3 | lbs | 1 | 349.9 | 221319 | lbs | 632.56 | bbls |
| | (100.48 | kg) | | | (100388.6 | kg) | (100.57 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 | kg) | | | (680.4 | kg) | (0.428 | m³) |
| CF DESCO | 1 | lb | 1.60 | 560.8 | 1000 | lb | 1.78 | bbls |
| deflocculant | (0.45 | kg) | | | (453.6 | kg) | (0.283 | m³) |
| Barite | 522.2 | lbs | 4.23 | 1482.6 | 522181 | lbs | 352.20 | bbls |
| | (236.9 | kg) | | | (236857 | kg) | (56.0 | m³) |

| | | | | |
|---|---|---|---|---|
| Total | 756,000 | lbs | 1,000 | bbls |
| | (342916 | kg) | (159 | m³) |

TABLE 2

| | |
|---|---|
| Target Volume | 1000 bbls (159 m³) |
| Target Density | 18 lb/gallon (2.16 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of | | | Density | Required for | | Required for | |
| ADDITIVES | Target Volume | | SG | [lbs/bbl] | Target Volume | | Target Volume | |
| Water | 259.3 | lbs | 1 | 349.9 | 259301 | lbs | 741.12 | bbls |
| | (117.6 | kg) | | | (117617 | kg) | (117.8 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 | kg) | | | (680.4 | kg) | (0.428 | m³) |
| CF DESCO | 1 | lb | 1.60 | 560.8 | 1000 | lbs | 1.78 | bbls |
| deflocculant | (0.45 | kg) | | | (453.6 | kg) | (0.283 | m³) |
| Scheelite Con | 484.2 | lbs | 5.67 | 1987.4 | 484199 | lbs | 243.64 | bbls |
| | (219.6 | kg) | | | (219629 | kg) | (38.7 | m³) |

| | | | | |
|---|---|---|---|---|
| Total | 756,000 | lbs | 1,000 | bbls |
| | (342916 | kg) | (159 | m³) |

TABLE 3

| | |
|---|---|
| Target Volume | 1000 bbls (159 m³) |
| Target Density | 18 lb/gallon (2.16 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of | | | Density | Required for | | Required for | |
| ADDITIVES | Target Volume | | SG | [lbs/bbl] | Target Volume | | Target Volume | |
| Water | 278.2 | lbs | 1 | 349.9 | 278191 | lbs | 795.11 | bbls |
| | (126.2 | kg) | | | (126185 | kg) | (126.4 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 | kg) | | | (680.4 | kg) | (0.428 | m³) |
| CF DESCO | 1 | lb | 1.60 | 560.8 | 1000 | lbs | 1.78 | bbls |
| deflocculant | (0.45 | kg) | | | (453.6 | kg) | (0.283 | m³) |
| Wolframite | 465.3 | lbs | 7 | 2453.5 | 465309 | lbs | 189.65 | bbls |
| | (211.1 | kg) | | | (211060 | kg) | (30.15 | m³) |

| | | | | |
|---|---|---|---|---|
| Total | 756,000 | lbs | 1,000 | bbls |
| | (342916 | kg) | (159 | m³) |

TABLE 4

| | |
|---|---|
| Target Volume | 1000 bbls (159 m³) |
| Target Density | 18 lb/gallon (2.16 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of | | | Density | Required for | | Required for | |
| ADDITIVES | Target Volume | | SG | [lbs/bbl] | Target Volume | | Target Volume | |
| Water | 322.7 | lbs | 1 | 349.9 | 322725 | lbs | 922.40 | bbls |
| | (146.4 | kg) | | | (146386 | kg) | (146.65 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 | kg) | | | (680.4 | kg) | (0.428 | m³) |
| CF DESCO | 1 | lb | 1.60 | 560.8 | 1000 | lbs | 1.78 | bbls |
| deflocculant | (0.45 | kg) | | | (453.6 | kg) | (0.283 | m³) |
| Tungsten | 420.8 | lbs | 19.25 | 6747.3 | 420775 | lbs | 62.36 | bbls |
| powder | (190.9 | kg) | | | (190860 | | (9.91 | m³) |

| | | | | |
|---|---|---|---|---|
| Total | 756,000 | lbs | 1,000 | bbls |
| | (342916 | kg) | (159 | m³) |

The results indicate that in order to achieve the same density for 1000 bbls (159 m³) of a WBM (i.e., 18 ppg (2.16 kg/L)), when barite was used, the weighting material was required in an amount of 522,181 lbs (236,857 kg) which had a volume of 352.20 bbls (56.0 m³). However, when a HDWM of the type disclosed herein was used a reduced amount of material was required to achieve the same density (18 ppg (2.16 kg/L)) resulting in a significant reduction in the mass and volume of weighting material used in preparation of the WBM. For example, when using scheelite as the weighting material, the WBM only required 484,199 lbs (219,629 kg) (243.64 bbls (38.7 m³)) while the use of wolframite and tungsten metal powder required 465,309 lbs (211,061 kg) (189.65 bbls (30.2 m³)) and 420,775 lbs (190,860 kg) (62.36 bbls (9.9 m³)) respectively. Under the same conditions, when substituting a HDWM for barite, the volume of water that could be used in the drilling mud was increased from 632.56 bbls (100.6 m³) in the case of barite to 741.12 bbls (117.8 m³) in the case of scheelite, to 795.11 bbls (126.4 m³) in the case of wolframite, and to 922.40 bbls (146.6 m³) in the case of tungsten metal powder. The results indicate that the use of a HDWM allows for the use of more water per unit of drilling fluid, when compared to barite, which may be desirable in designing a drilling mud composition.

### Example 2

The amount and volume of weighting material necessary to achieve a WBM density of 12 ppg (1.44 kg/L) was investigated. Specifically, barite and a HDWM comprising either scheelite, wolframite or tungsten metal powder were compared For each table, the components of each WBM are presented along with the density and the specific gravity of each component. The amount of material weight in pounds per bbl of final total target volume is given in each table. The amount of material, weight in pounds, to prepare 1000 barrels (bbls) (159 m³) of a 12 ppg (1.44 kg/L) WBM was calculated and the amount of material, volume in barrels, to achieve the target volume and density is also presented. Table 5 provides the information for preparation of 1000 bbls (159 m³) of a 12 ppg (1.44 kg/L) WBM using barite as a weighting material while for Tables 6, 7, and 8 the barite is replaced with scheelite, wolframite and tungsten metal powder respectively.

TABLE 5

| | |
|---|---|
| Target Volume | 1000 bbls (159 m³) |
| Target Density | 12 lb/gallon (1.44 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of | | | Density | Required for | | Required [bbls] | |
| ADDITIVES | Target Volume | | SG | [lbs/bbl] | Target Volume | | for Target Volume | |
| Water | 299.2 | lbs | 1 | 349.9 | 299154 | lbs | 855.03 | bbls |
| | (135.7 | kg) | | | (135694 | kg) | (135.94 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 | kg) | | | (680.4 | kg) | (0.428 | m³) |
| CF DESCO | 1 | lb | 1.60 | 560.8 | 1000 | lbs | 1.78 | bbls |
| deflocculant | (0.45 | kg) | | | (453.6 | kg) | (0.283 | m³) |
| Barite | 192.3 | lbs | 4.23 | 1482.6 | 192346 | lbs | 129.73 | bbls |
| | (872.5 | kg) | | | (87246.7 | kg) | (20.63 | m³) |

| | | | | |
|---|---|---|---|---|
| Total | 504,000 | lbs | 1,000 | bbls |
| | (228611 | kg) | (159 | m³) |

TABLE 6

| | |
|---|---|
| Target Volume | 1000 bbls (159 m³) |
| Target Density | 12 lb/gallon (1.44 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of | | | Density | Required for | | Required for | |
| ADDITIVES | Target Volume | | SG | [lbs/bbl] | Target Volume | | Target Volume | |
| Water | N/A | | 1 | 349.9 | 313145 | lbs | 895.02 | bbls |
| | | | | | (142044 | kg) | (142.30 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 k | kg) | | | (680.4 | kg) | (0.428 | m³) |
| CF DESCO | 1 | lb | 1.60 | 560.8 | 1000 | lbs | 1.78 | bbls |
| deflocculant | (0.45 | kg) | | | (453.6 | kg) | (0.283 | m³) |

| | | | | | | | |
|---|---|---|---|---|---|---|---|
| Scheelite Con | N/A | 5.67 | 1987.4 | 178355 | lbs | 89.74 | bbls |
| | | | | (80900.75 | kg) | (14.27 | m³) |

| | | | | |
|---|---|---|---|---|
| Total | 504,000 | lbs | 1,000 | bbls |
| | (228611 | kg) | (159 | m³) |

TABLE 7

| | |
|---|---|
| Target Volume | 1000 bbls (159 m³) |
| Target Density | 12 lb/gallon (1.44 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of Target | | | Density | Required for | | Required for | |
| ADDITIVES | Volume | | SG | [lbs/bbl] | Target Volume | | Target Volume | |
| Water | N/A | | 1 | 349.9 | 320103 | lbs | 914.90 | bbls |
| | | | | | (145196 | kg) | (145.46 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 | kg) | | | (680.4 | kg) | (0.428 | m³) |
| CF DESCO | 1 | lb | 1.60 | 560.8 | 1000 | lbs | 1.78 | bbls |
| deflocculant | (0.45 | kg) | | | (453.6 | kg) | (0.283 | m³) |

| | | | | | | | |
|---|---|---|---|---|---|---|---|
| Wolframite | N/A | 7 | 2453.5 | 171397 | lbs | 69.86 | bbls |
| | | | | (77744.4 | kg) | (11.1 | m³) |

| | | | | |
|---|---|---|---|---|
| Total | 504,000 | lbs | 1,000 | bbls |
| | (228611 | kg) | (159 | m³) |

TABLE 8

| | |
|---|---|
| Target Volume | 1000 bbls (159 m³) |
| Target Density | 12 lb/gallon (1.44 kg/L) @ 68° F. (20° C.) |

| | Amount of Material | | | | | | | |
|---|---|---|---|---|---|---|---|---|
| | Required per bbl | | | Material | Amount of Material | | Volume of Material | |
| | (159 L) of | | | Density | Required for | | Required for | |
| ADDITIVES | Target Volume | | SG | [lbs/bbl] | Target Volume | | Target Volume | |
| Water | N/A | | 1 | 349.9 | 336507 | lbs | 961.379 | bbls |
| | | | | | (152637 | kg) | (152.9 | m³) |
| Bentonite | 10 | lbs | 2.65 | 928.8 | 10000 | lbs | 10.77 | bbls |
| | (4.54 | kg) | | | (4536 | kg) | (1.71 | m³) |
| DRISPAC | 1.5 | lbs | 1.59 | 557.3 | 1500 | lbs | 2.69 | bbls |
| polymer | (0.68 | kg) | | | (680.4 | kg) | (0.428 | m³) |
| CF DESCO | 1 | lb | 1.60 | 560.8 | 1000 | lbs | 1.78 | bbls |
| deflocculant | (0.45 | kg) | | | (453.6 | kg) | (0.283 | m³) |

| | | | | | | | |
|---|---|---|---|---|---|---|---|
| Tungsten | N/A | 19.25 | 6747.3 | 154993 | lbs | 22.97 | bbls |
| powder | | | | (70303.6 | kg) | (3.65 | m³) |

| | | | | |
|---|---|---|---|---|
| Total | 504,000 | lbs | 1,000 | bbls |
| | (228611 | kg) | (159 | m³) |

The results indicate that in order to achieve the same density for 1000 bbls (159 m³) of drilling mud (i.e., 12 ppg (1.44 kg/L)), when barite was used, the weighting material was required in an amount of 192,346 lbs (87247 kg) which occupied a volume of 129.73 bbls (20.6 m³). However, when a HDWM of the type disclosed herein was use, a reduced amount of weighting material was required to achieve the same density (12 ppg (1.44 kg/L)) resulting in a significant reduction in the mass and volume of weighting material used in the preparation of the WBM. For example when using scheelite as the weighting material 178,355 lbs (80901 kg) (89.74 bbls (14.27 m³)) was used while the use of wolframite and tungsten metal powder required 171,397 lbs (69.86 bbls (11.10 m³)) and 154,993 lbs (22.97 bbls (3.65 m³)) respectively. Under the same conditions, when substituting a HDWM of the type disclosed herein for barite, the volume of water that could be used for the drilling mud was increased from 855.03 bbls (135.94 m³) in the case of barite to 895.02 bbls (142.30 m³) in the case of scheelite concentrate, to 914.90 bbls 145.46 m³) in the case of wolframite, and to 961.79 bbls (152.91 m³) in the case of tungsten metal powder. The results presented in Example 2 indicate that the use of a HDWM of the type disclosed herein allows for more water per unit of drilling fluid, when compared to barite, which may be desirable in designing a drilling mud composition.

### Example 3

The rheology of a WBM comprising a HDWM of the type disclosed herein was investigated. Specifically, the effect of substituting barite with scheelite on the fluid rheology of a WBM was studied. Each of the weighting materials (i.e., barite and scheelite) were used for preparing WBMs having a density of either 12 ppg (1.44 kg/L) or 18 ppg (2.16 kg/L). In addition each of the four samples, designated Samples 1-4, contained 10 g bentonite with a volume of 3.774 cc, 1 g of DRISPAC polymer with a volume of 0.629 cc, and 1 g of CF DESCO deflocculant with a volume of 0.625 cc. The volume of water and the mass of the weighting material were calculated for each sample and the results are shown in Table 9.

TABLE 9

| | | | | | | | | | % Reduction in |
|---|---|---|---|---|---|---|---|---|---|
| | Density | | | | | | | | weighting material |
| Sample | (ppg) [kg/L] | Units | Water | Barite | Scheelite concentrate | Total | | % Increase in H₂O* | amount* |
| 1 | 12 | g | 299.4 | 192.78 | 0 | 504.18 | | | |
| | [1.44] | cc | 299.4 | 45.574 | 0 | 350.002 | | | |
| 2 | 18 | g | 221.4 | 522.91 | 0 | 756.31 | | | |
| | [2.16] | cc | 221.4 | 123.62 | 0 | 350.048 | | | |
| 3 | 12 | g | 313.5 | 0 | 178.73 | 504.23 | mass | 4.71% | 7.29% |
| | [1.44] | cc | 313.5 | 0 | 31.521 | 350.049 | vol | 4.71% | 30.84% |
| 4 | 18 | g | 259.5 | 0 | 484.8 | 756.3 | mass | 17.21% | 7.29% |
| | [2.16] | cc | 259.5 | 0 | 85.502 | 350.03 | vol | 17.21% | 30.83% |

*Comparisons are made to the fluid composition when using barite as a weighting material

Samples 1 and 2 utilized barite as the weighting material while Samples 3 and 4 utilized a HDWM of the type disclosed herein, scheelite. The use of scheelite instead of barite lead to an increase of 4.71% in the volume of water that could be used in the WBM for the 12 ppg (1.44 kg/L) drilling mud and 17.21% for the 18 ppg (2.16 kg/L) drilling mud. The use of scheelite instead of barite also lead to a decrease in the amount of the weighting material required to achieve the target density (i.e., 12 ppg (1.44 kg/L) or 18 ppg (2.16 kg/L)) of 7.29%, which corresponded to a decrease in the volume of the weighting material of 30.84%.

Rheology tests were performed on Samples 1-4 using a Fann 35 viscometer (in the 2× spring factor (SF) configuration for sample 2), under ambient conditions of pressure and temperature. The samples were tested for their initial rheology after mixing (Table 10) or after having been aged for 16 hours (Table 11). Both Tables 10 and 11 provide the Fann viscometry readings at 3, 4, 100, 200, 300, and 600 rpm, the plastic viscosity (PV) cP and yield point (YP) lbs/100 ft² of the samples.

TABLE 10

| | | Initial Rheology | | | | | | | | | |
|---|---|---|---|---|---|---|---|---|---|---|---|
| | | | | | | | | | YP | % | % |
| | | | | | | | | | (lbs/100 ft²) | Reduction | Reduction |
| Sample | | θ600 RPM | θ 300 RPM | θ 200 RPM | θ 100 RPM | θ 6 RPM | θ 3 RPM | PV (cP) | (Pa) | in PV | in YP |
| 1 | Note: | 116 | 82.5 | 67 | 47 | 13 | 10 | 33.5 | 49 lbs/ | | |
| | Fann 35 | | | | | | | | 100 ft² | | |
| | Rheometer | | | | | | | | (23.5 Pa) | | |
| 2 | equipped | 260 | 182 | 149 | 111 | 43 | 37 | 156 | 49 lbs/ | | |
| | with an F2 | | | | | | | | 100 ft² | | |
| | torsion | | | | | | | | (99.84 Pa) | | |
| 3 | spring | 90 | 68 | 55 | 38 | 8 | 6 | 22 | 46 lbs/ | 34.3% | 6.1% |
| | used to | | | | | | | | 100 ft² | | |
| | measure | | | | | | | | (22.8 Pa) | | |
| 4 | rheology | 191 | 138 | 110 | 78 | 23 | 18 | 53 | 85 lbs/ | 66.0% | 59.1% |
| | for | | | | | | | | 100 ft² | | |
| | Sample 2 | | | | | | | | (40.8 Pa) | | |

Where θ is the dial deflection of the rheometer, i.e., the rotation of the bob.

TABLE 11

| | Aged Rheology (16 h ambient) | | | | | | | | | | |
|---|---|---|---|---|---|---|---|---|---|---|---|
| | | | | | | | | YP (lbs/ | Gels lbs/ | % | % |
| | | | | | | | PV | 100 ft²) | 100 ft² (Pa) | Reduction | Reduction |
| Sample | θ 600 RPM | θ 300 RPM | θ 200 RPM | θ 100 RPM | θ 6 RPM | θ 3 RPM | (cP) | (Pa) | 10 sec:10 min | in PV | in YP |
| 1 | 113 | 78 | 62 | 43 | 10 | 8 | 35 | 43 lbs/ | 9:32 lbs/ | | |
| | | | | | | | | 100 ft² | 100 ft² | | |
| | | | | | | | | (20.6 Pa) | (4.3:15 Pa) | | |
| 2 | 199 | 135 | 108 | 75 | 25 | 21 | 128 | 142 lbs/ | 25:60 lbs/ | | |
| | | | | | | | | 100 ft² | 100 ft² | | |
| | | | | | | | | (68.16 Pa) | (12.0:28.7 Pa) | | |
| 3 | 95 | 69 | 53 | 35 | 6 | 4 | 26 | 43 lbs/ | 4:18 lbs/ | 25.7% | 0.0% |
| | | | | | | | | 100 ft² | 100 ft² | | |
| | | | | | | | | (20.6 Pa) | (1.9:8.6 Pa) | | |
| 4 | 176 | 120 | 94 | 64 | 15 | 12 | 56 | 64 lbs/ | 3:44 lbs/ | 56.3% | 54.9% |
| | | | | | | | | 100 ft² | 100 ft² | | |
| | | | | | | | | (30.7 Pa) | (1.4:21.1 Pa) | | |

The results demonstrate that drilling mud properties such as the PV (plastic viscosity) cP, YP (yield point) lbs/100 ft² (Pa) and gels (gel strengths lbs/100 ft² (Pa) at 10 seconds, and 10 minutes) decreased rather noticeably as the weighting material was substituted from barite in Samples 1 and 2 to scheelite in samples 3 and 4. The only exception is the YP for scheelite at 16 h for the 12 ppg (1.44 kg/L) drilling mud, where the value is the same for barite at 16 h for the same density drilling mud. Further, the PV and YP values were fairly stable after aging for 16 hours. Gel strengths were significantly and beneficially lower in the samples containing a HDWM of the type disclosed herein (i.e., Samples 3 and 4).

### Example 4

The effects of the addition of a HDWM of the type described herein on a cement slurry were determined. Specifically, the effect of substituting hematite, with either tungsten metal powder or scheelite on the cement slurry rheology was studied. Three cement slurries were prepared, each having a density of 17.94 ppg (2.15 kg/L) and a total slurry volume of 600 mL. Cement slurry 1 (CS1) contained hematite as the weighting material, cement slurry 2 (CS2) contained tungsten metal powder as the HDWM, and cement slurry 3 (CS3) contained scheelite as the HDWM. The cement slurries were prepared at 73° F. (22.8° C.), at which temperature the density of water used for calculations is 8.3248 ppg (1.0 kg/L). The weight of cement used was adjusted to keep the final cement slurry volume at 600 mL. Cement Class G was used in all three cases. Additionally, the samples contained the indicated amounts of DIACEL RPM powder and liquid cement dispersant additive, DIACEL FL powder cement fluid-loss additive, DIACEL HTR-100 powder cement retarder additive, DIACEL HTR-200 powder and/or DIACEL ATF liquid cement antifoam additive. DIACEL RPM powder and liquid cement dispersant additive is a cement dispersant additive, DIACEL FL powder cement fluid-loss additive is a non-retarding cement fluid loss additive, DIACEL HTR-100 powder cement retarder additive and DIACEL HTR-200 powder are high-temperature cement retarder additives, and DIACEL ATF liquid cement antifoam additive is a liquid cement antifoam additive, all of which are commercially available from Chevron Philips Chemical Company LP. The amount of deionized water used was calculated for all three cement slurries as follows: 7.245 gal/SK (gallons per sack of cement) (22.78 weight %) for CS1, 6.671 gal/SK (24.18 weight %) for CS2, and 6.671 gal/SK (22.67 weight %) for CS3. In all three cases the liquid additive DIACEL ATF liquid cement antifoam additive was used at 0.05 gal/SK (0.16, 0.18, and 0.17 weight % for CS1, CS2, CS3 respectively), resulting in the total fluids used per sack of cement as follows: 7.295 gal/SK for CS1, 6.721 gal/SK for CS2, and 6.721 gal/SK for CS3 (22.94, 24.36, 22.84 weight % for CS1, CS2, and CS3 respectively). In all three cases the weight of a cement sack was 94 lbs/SK (42.6 kg). The yield was calculated for all three cement slurry compositions as follows: 1.97 ft³/SK (0.0558 m³/SK) for CS1, 1.71 ft³/SK (0.0484 m³/SK) for CS2, and 1.83 ft³/SK (0.0518 m³/SK) for CS3.

The weight/volume of each component used in preparing the cement samples are presented in Table 12 for CS1, in Table 13 for CS2, and in Table 14 for CS3.

TABLE 12

| Dry Blend | [g] | Liquid Additions | [g] |
|---|---|---|---|
| Cement | 458 | Mix Water | 293.85 |
| | 0 | DIACEL ATF | 2.033 |
| | | liquid cement | |
| | | antifoam additive | |
| DIACEL RPM | 5.725 | | |
| powder and liquid | | | |
| cement dispersant | | | |
| additive | | | |
| DIACEL FL powder | 9.16 | | |
| cement fluid-loss | | | |
| additive (dry) | | | |
| DIACEL HTR-100 | 10.305 | | |
| powder cement | | | |
| retarder additive | | | |
| Silica Flour | 183.2 | | |
| Hematite | 320.6 | | |
| Sodium Borate | 3.435 | | |
| DIACEL HTR-200 | 3.435 | | |
| powder | | | |

TABLE 13

| Dry Blend | [g] | Liquid Additions | [g] |
|---|---|---|---|
| Cement | 528 | Mix Water | 311.95 |
| | 0 | DIACEL ATF | 2.344 |
| | | liquid cement | |
| | | antifoam additive | |
| DIACEL RPM | 6.6 | | |
| powder and liquid | | | |
| cement dispersant | | | |
| additive | | | |
| DIACEL FL powder | 10.56 | | |
| cement fluid-loss | | | |
| additive (dry) | | | |
| DIACEL HTR-100 | 14.52 | | |
| powder cement | | | |
| retarder additive | | | |
| Silica Flour | 211.2 | | |
| Tungsten Powder | 199.584 | | |
| Sodium Borate | 3.96 | | |
| DIACEL HTR-200 | 1.32 | | |
| powder | | | |

TABLE 14

| Dry Blend | [g] | Liquid Additions | [g] |
|---|---|---|---|
| Cement | 495 | Mix Water | 292.45 |
| | 0 | DIACEL ATF | 2.197 |
| | | liquid cement | |
| | | antifoam additive | |
| DIACEL RPM | 6.1875 | | |
| powder and liquid | | | |
| cement dispersant | | | |
| additive | | | |
| DIACEL FL powder | 9.9 | | |
| cement fluid-loss | | | |
| additive (dry) | | | |
| DIACEL HTR-100 | 13.6125 | | |
| powder cement | | | |
| retarder additive | | | |
| Silica Flour | 198 | | |
| Scheelite Concentrate | 267.795 | | |
| Sodium Borate | 3.7125 | | |
| DIACEL HTR-200 | 1.2375 | | |
| powder | | | |

The amount of each component used in preparing the cement slurries were also calculated as the percent by weight of cement and the data is displayed in Table 15 for CS1, in Table 16 for CS2, and in Table 17 for CS3.

TABLE 15

| | [gal/SK] | % by weight of | |
|---|---|---|---|
| ADDITIVES: | (liquid | cement slurry | SG |
| DESCRIPTION | additives) | (dry additives) | (of additive) |
| DIACEL ATF liquid | 0.05 | 0.00% | 1 |
| cement antifoam additive | | | |
| DIACEL RPM powder | 0 | 1.25% | 1.35 |
| and liquid cement | | | |
| dispersant additive | | | |
| DIACEL FL powder | 0 | 2.00% | 1.66 |
| cement fluid-loss additive | | | |
| (dry) | | | |
| DIACEL HTR-100 | 0 | 2.25% | 1.2 |
| powder cement retarder | | | |
| additive | | | |
| Silica Flour | 0 | 40.00% | 2.65 |
| Hematite | 0 | 70.00% | 4.95 |
| Sodium borate | 0 | 0.75% | 1.73 |
| DIACEL HTR-200 | 0 | 0.75% | 1.26 |
| powder | | | |

TABLE 16

| | | % by weight of | |
|---|---|---|---|
| ADDITIVES: | [gal/SK] | cement slurry | SG |
| DESCRIPTION | (liquid | (dry additives) | (of additive) |
| | additives) | | |
| DIACEL ATF liquid | 0.05 | 0.00% | 1 |
| cement antifoam additive | | | |
| DIACEL RPM powder | 0 | 1.25% | 1.35 |
| and liquid cement | | | |
| dispersant additive | | | |
| DIACEL FL powder | 0 | 2.00% | 1.66 |
| cement fluid-loss additive | | | |
| (dry) | | | |
| DIACEL HTR-100 | 0 | 2.75% | 1.2 |
| powder cement | | | |
| retarder additive | | | |
| Silica Flour | 0 | 40.00% | 2.65 |
| Tungsten Powder | 0 | 37.80% | 19.25 |
| Sodium borate | 0 | 0.75% | 1.73 |
| DIACEL HTR-200 | 0 | 0.25% | 1.26 |
| powder | | | |

TABLE 17

| | [gal/SK] | % by weight of | |
|---|---|---|---|
| ADDITIVES: | (liquid | cement slurry | SG |
| DESCRIPTION | additives) | (dry additives) | (of additive) |
| DIACEL ATF liquid | 0.05 | 0.00% | 1 |
| cement antifoam additive | | | |
| DIACEL RPM powder | 0 | 1.25% | 1.35 |
| and liquid cement | | | |
| dispersant additive | | | |
| DIACEL FL powder | 0 | 2.00% | 1.66 |
| cement fluid-loss additive | | | |
| (dry) | | | |
| DIACEL HTR-100 | 0 | 2.75% | 1.2 |
| powder cement | | | |
| retarder additive | | | |
| Silica Flour | 0 | 40.00% | 2.65 |
| Scheelite Concentrate | 0 | 54.10% | 5.67 |
| Sodium borate | 0 | 0.75% | 1.73 |
| DIACEL HTR-200 | 0 | 0.25% | 1.26 |
| powder | | | |

The results indicate that when the weighting material hematite was substituted with a HDWM of the type disclosed herein, the amount of weighting material needed decreased from 70% by weight of cement for hematite to 54.1% by weight of cement for scheelite, and to 37.8% by weight of cement for tungsten metal powder. The amount of cement included in the slurry was increased from 458 g for CS1 which contained hematite as a weighting material to 528 g for CS2 and to 495 g for CS3 which contained tungsten metal powder and scheelite respectively. While the amount of water is practically the same for CS1 (293.85 g) and CS3 (292.45 g), the use of tungsten metal powder which has a high SG (19.25) also allowed for an increase of the water amount to 311.95 g, along with the increase in the mass. The use of HDWMs of the type disclosed herein as weighting materials with a high SG allows for more cement to be added to the slurry to achieve equal slurry volume with the same density.

Rheology tests were performed on each of the three cement slurries at 80° F. (26.7° C.) and the results are presented in Table 18. The rheology tests were performed using a Fann 35 viscometer, equipped with a F2 torsion spring.

TABLE 18

| Cement Slurry | Test | | | | | | | PV | |
|---|---|---|---|---|---|---|---|---|---|
| Composition | Temp | θ 600 RPM | θ 300 RPM | θ 200 RPM | θ 100 RPM | θ 6 RPM | θ 3 RPM | (cP) | YP |
| CS1 | 80° F. | >300 | 260 | 188 | 110 | 15 | 11 | 450 | 70 |
| | (26.7° C.) | | | | | | | | (lbs/(100 ft²) |
| | | | | | | | | | (33.5 Pa) |
| CS2 | 80° | 280 | 162 | 118 | 67 | 9.5 | 6.5 | 285 | 39 |
| | (26.7° C.)F. | | | | | | | | (lbs/100 ft²) |
| | | | | | | | | | (18.7 Pa) |
| CS3 | 80° | >300 | 219 | 150 | 85.5 | 11 | 7 | 400.5 | 37.5 (lbs/ |
| | (26.7° C.)F. | | | | | | | | 100 ft²) |
| | | | | | | | | | (18.0 Pa) |

The results demonstrate the improvement in slurry rheology as evidenced by the lower plastic viscosity when replacing the conventional weight material with the HDWM.

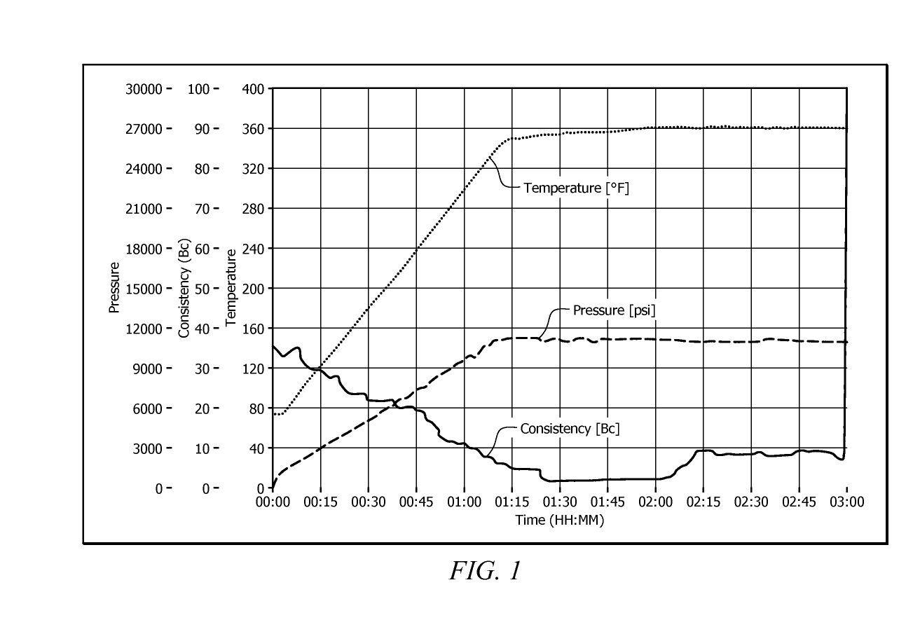

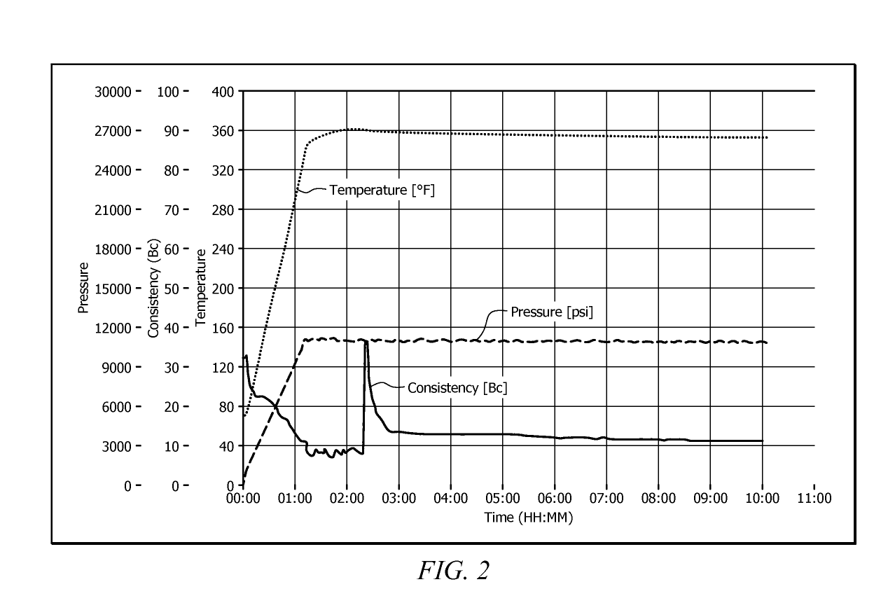

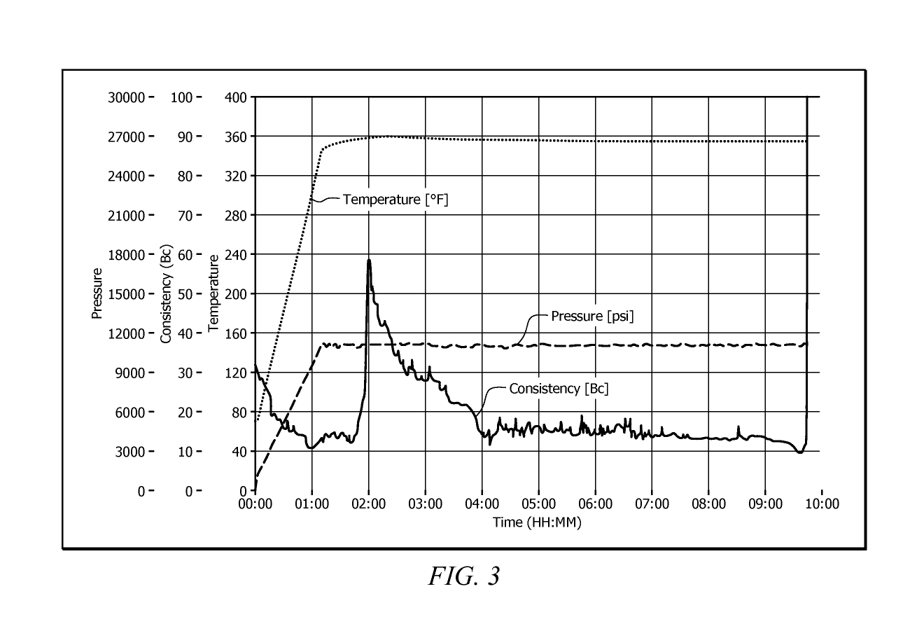

The thickening time for each cement slurry was also determined using a high pressure/high temperature Bearden Consistometer. Herein the thickening time refers to the duration that a cement slurry remains in a fluid state and is capable of being pumped. In all cases the thickening time was determined using a bottom hole static temperature (BHST) 446° F. (230° C.) and a bottom hole circulating temperature (BHCT) of 356° F. (180° C.). The temperature was increased from approximately 80° F. (26.7° C.) to the BHCT (356° F.) (180° C.). The pressure was increased from the initial pressure Pᵢ=750 psi (5170 kPa) to the final pressure P_{f}=11000 psi (75842 kPa). The instrument was programmed to ramp up both the temperature and the pressure over a period of 70 minutes. The thickening times for each of the cement slurries are presented in Table 19 and are plotted in FIG. 1 for CS1, in FIG. 2 for CS2, and in FIG. 3 for CS3.

TABLE 19

| Cement Slurry | BC(I) | POD | | | |
|---|---|---|---|---|---|
| Composition | [B_{c}] | [hh:mm] | 30 B_{c} | 70 B_{c} | 100 B_{C} |
| CS1 | 35 | 2:58 | 2:59 | 2:59 | 2:59 |
| CS2 | 31 | 9:59 | 10:00 | 10:01 | 10:02 |
| CS3 | 32 | 9:39 | 9:44 | 9:45 | 9:45 |

BC(I) is the initial viscosity reading. POD is the point of departure and refers to the time at which the consistency reading was observed to begin to increase sharply. B_{c} stands for Bearden Unit of Consistency, which is a dimensionless parameter. The results demonstrate the thickening times were much longer for the cement slurries prepared with a HDWM of the type disclosed herein as the weighting material (10 h 2 min for CS2 based on tungsten metal powder, and 9 h 45 min for CS3 based on scheelite) when compared to cement slurries prepared using hematite as the weighting material (2 h 59 min for CS1). These results demonstrate the thickening time was not adversely shortened. The examples show the effects of the additional water and the additional design latitude.

Without further elaboration, it is believed that one skilled in the art can, using the description herein, utilize the present invention to its fullest extent. While preferred inventive aspects have been shown and described, modifications thereof can be made by one skilled in the art without departing from the spirit and teachings of the invention. The embodiments and examples described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent that they provide exemplary, procedural or other details supplementary to those set forth herein.

What is claimed is:

1. A wellbore treatment fluid comprising one or more high-density weighting materials selected from the group consisting of tungsten-containing materials, bismuth-containing materials, and tin-containing materials.

2. The wellbore treatment fluid of claim 1 comprising one or more tungsten-containing materials selected from the group consisting of tungsten metal, scheelite, wolframite, and cuproscheelite.

3. The wellbore treatment fluid of claim 1 comprising one or more bismuth-containing materials selected from the group consisting of bismuth metal, bismuthinite, and bismite.

4. The wellbore treatment fluid of claim 1 comprising one or more tin-containing materials selected from the group consisting of tin metal, cassiterite, and romarchite.

5. The wellbore treatment fluid of claim 1, wherein the treatment fluid is formulated as a drilling fluid or a settable sealant composition.

6. The wellbore treatment fluid of claim 5, wherein the wellbore treatment fluid is formulated as a drilling fluid comprising (i) one or more liquids selected from the group consisting of an aqueous liquid and an oleaginous liquid and (ii) an effective amount of a high-density weighting material such that the wellbore treatment fluid has a density greater than about 9 ppg (1.08 kg/L).

7. The wellbore treatment fluid of claim 6, wherein the treatment fluid is a water-based drilling mud or an oil-based drilling mud.

8. The wellbore treatment fluid of claim 6, wherein the high-density weighting material is present in amount of from about 1 wt. % to about 80 wt. % based on the total weight of the treatment fluid.

9. The wellbore treatment fluid of claim 5, wherein the wellbore treatment fluid is formulated as a settable sealant composition comprising (i) an effective amount of a hydraulic cement binder to form a settable composition, (ii) an effective amount of an aqueous fluid to form a pumpable slurry, and (iii) an effective amount of the one or more high-density weighting material such that the slurry has a density greater than about 16.5 ppg (1.98 kg/L).

10. The wellbore treatment fluid of claim 9 comprising one or more hydraulic cement binders selected from the group consisting of Portland cement blends, Pozzolan-lime cements, slag cements, calcium aluminate cements, natural cements, geopolymer cements, microfine cements, and fine grind lightweight type cements.

11. The wellbore treatment fluid of claim 9, wherein the high-density weighting material comprises a material with a specific gravity greater than about 5.5.

12. The wellbore treatment fluid of claim 10 comprising one or more tungsten-containing materials selected from the group consisting of tungsten metal in powder form and a tungsten metal oxide.

13. The wellbore treatment fluid of claim 12 comprising one or more tungsten metal oxides selected from the group consisting of scheelite, wolframite, and cuproscheelite.

14. The wellbore treatment fluid of claim 10 comprising one or more bismuth-containing materials selected from the group consisting of bismuth metal in powder form, a bismuth metal oxide, and a bismuth metal sulfide.

15. The wellbore treatment fluid of claim 10 comprising one or more bismuth-containing materials selected from the group consisting of bismuthinite and bismite.

16. The wellbore treatment fluid of claim 10 comprising one or more tin-containing materials selected from the group consisting of tin metal, a tin metal oxide, and a tin metal sulfide.

17. The wellbore treatment fluid of claim 10 comprising one or more tin-containing materials selected from the group consisting of cassiterite and romarchite.

18. The wellbore treatment fluid of claim 9, wherein the high-density weighting material is characterized by a particle size distribution of equal to or less than about 200 mesh (75 μm).

19. The wellbore treatment fluid of claim 9, wherein the high-density weighting material is present in amount of from about 5 wt. % wt. % to about 150 wt. % based on the total weight of the wellbore treatment fluid.

20. A method comprising placing the wellbore treatment fluid of claim 1 into a wellbore.
